(19) United States
(12) Patent Application Publication
(10) Pub. No.: US 2022/0114147 A1
(43) Pub. Date: Apr. 14, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: SHINGO ASO, TOKYO (JP); YUTO HOSOGAYA, KANAGAWA (JP)

(21) Appl. No.: 17/309,636

(22) PCT Filed: Dec. 3, 2019
(86) PCT No.: PCT/JP2019/047184

§ 371 Date: Jun. 11, 2021

(30) Foreign Application Priority Data
Dec. 19, 2018 (JP) 2018-236857

(51) Int. Cl. G06F 16/18; G06F 3/06

(52) U.S. Cl. CPC G06F 16/1865; G06F 3/0673; G06F 3/064; G06F 3/0604

(57) ABSTRACT

An information processing apparatus in which data is accessed every predetermined data amount, wherein when writing data transmitted from a host system side, in the case where the data is presumed to be continuous data constituting a single file, metadata indicating that the data from the host system side is continuous data is written along with the data.

### TECHNICAL FIELD

The present disclosure relates to an information processing apparatus, an information processing method, and an information processing program. More specifically, the present disclosure relates to an information processing apparatus, an information processing method, and an information processing program in which data is accessed every predetermined data amount.

### BACKGROUND ART

In recent years, information processing apparatuses such as hard disks, silicon disks using flash memory or the like, and so on are being widely used as information processing apparatuses that store digital data. Digital data is normally stored in an information processing apparatus using a file system.

For example, when a hard disk is formatted to construct what is known as the FAT file system, a file allocation table, a root directory region, and the like are formed within the hard disk. A host system such as an operating system (OS) normally manages data in units of clusters, each constituted by a plurality of sectors, and binary data constituting files is read and written in units of sectors. In addition to filenames and attributes, information such as starting cluster numbers of files that are stored is held in the root directory region as directory entries.

The host system obtains the starting cluster number of a file by referring to the directory entry, and on the basis thereof, refers to the entry of the starting cluster number in the file allocation table to obtain the next cluster number. The host system then refers to the entry of the next cluster number in the file allocation table, and obtains the next cluster number thereafter. The cluster number where the binary data of a specific file is stored can be identified by continuing such operations.

An information processing apparatus which uses flash memory performs the same basic operations as those described above. For example, with NAND flash memory, reading is carried out in units of a plurality of bits, called pages. However, data cannot be overwritten directly in a page in which something is already recorded, and instead, it is necessary to first delete the entire page. Furthermore, it is necessary to delete the aforementioned pages in units of blocks, each of which contains a plurality of pages. Thus when rewriting data, it is necessary to perform processing in which new data is written to deleted blocks which have been deleted, and blocks in which old data had been written are deleted. As such, in NAND flash memory, data after a rewrite has to be written into a block different from the data before the rewrite (see PTL 1).

Accordingly, the correspondence relationship between a logical block address assigned from the host system side and a physical block address in the flash memory changes dynamically each time data is rewritten. Accordingly, an address conversion table, which indicates correspondence relationships between logical block addresses and physical block addresses, is necessary when accessing flash memory. Such processing is performed by a memory controller of the flash memory, and does not involve the host system. Accordingly, even if the host system assumes that sequential data has been written into sequential blocks, the data may actually have been written into non-sequential blocks instead.

### CITATION LIST

### Patent Literature

[PTL 1]

JP 2006-155335 A

### SUMMARY

### Technical Problem

For example, when index information of a file allocation table has been damaged or lost, and the file system is corrupted, files which have been written become inaccessible. In such a state, if a predetermined file is stored in sequential clusters or sequential blocks, an attempt can be made to recover the file by writing the binary data of the file on the basis of the continuity of the storage location. However, if the predetermined file is stored in non-sequential clusters or blocks, it is extremely difficult to recover the data on the basis of the continuity of the storage location. Particularly with flash memory, even if the host system assumes that sequential data has been written into sequential blocks, the data may actually have been written into non-sequential blocks instead, which makes it extremely difficult to recover the data.

Accordingly, an object of the present disclosure is to provide an information processing apparatus capable of identifying, to a certain extent, clusters, blocks, and the like in which the data of a written file is stored even when a file system is corrupted, as well as an information processing method and an information processing program of the stated information processing apparatus.

### Solution to Problem

An information processing apparatus according to the present disclosure for achieving the above-described object is an information processing apparatus in which data is accessed every predetermined data amount.

When writing data transmitted from a host system side, in the case where the data is presumed to be continuous data constituting a single file, metadata indicating that the data from the host system side is continuous data is written along with the data from the host system side.

An information processing method according to the present disclosure for achieving the above-described object is an information processing method including, when writing data transmitted from a host system side in an information processing apparatus in which data is accessed every predetermined data amount,

a step of determining whether or not the transmitted data is presumed to be continuous data constituting a single file, and

a step of, when the data is presumed to be continuous data, writing metadata indicating that the data from the host system side is continuous data along with the data from the host system side.

An information processing program according to the present disclosure for achieving the above-described object is an information processing program executed by a computer, the program controlling an information processing apparatus in which data is accessed every predetermined data amount, the program including, when writing data transmitted from a host system side:

a step of determining whether or not the transmitted data is presumed to be continuous data constituting a single file, and

a step of, when the data is presumed to be continuous data, writing metadata indicating that the data from the host system side is continuous data along with the data from the host system side.

### BRIEF DESCRIPTION OF DRAWINGS

FIG. 1 is a schematic block diagram of an information processing apparatus according to a first embodiment.

FIG. 2 is an explanatory diagram illustrating a relationship between blocks and pages in a storage device constituted by flash memory. FIG. 2A illustrates the structure of the block, and FIG. 2B illustrates the structure of the page included in the block.

FIG. 3 is an explanatory diagram illustrating how a logical block indicated from a host system side and a physical block on a storage device side can differ.

FIG. 4 is a schematic flowchart illustrating basic operations in write processing.

FIG. 5 is a schematic diagram illustrating data stored in each of pages of the storage device.

FIG. 6 is an explanatory diagram illustrating an example of write processing in the storage device.

FIG. 7 is an explanatory diagram illustrating details of metadata written in each page of the storage device in the operations illustrated in FIG. 6.

FIG. 8 is an explanatory diagram illustrating how a related page can be accessed on the basis of metadata regardless of file system information.

FIG. 9 is a schematic flowchart illustrating basic operations in write processing including a determination of the size of transmitted data.

FIG. 10 is a schematic flowchart illustrating details of exception processing in FIG. 9.

FIG. 11 is an explanatory diagram illustrating details of metadata written in each page of the storage device in the operations illustrated in FIG. 9 and FIG. 10.

FIG. 12 is an explanatory diagram illustrating a case of identifying a sector through LBA (Logical Block Addressing).

FIG. 13 is an explanatory diagram illustrating details of metadata in a case of identifying a sector through LBA.

FIG. 14 is an explanatory diagram illustrating an example of a case where data from a host system side and metadata are both written to a sector.

FIG. 15 is an explanatory diagram illustrating an example of a case where data from a host system side and metadata are stored in independent recording regions.

### DESCRIPTION OF EMBODIMENTS

The present disclosure will be described below on the basis of embodiments, with reference to the drawings. The present disclosure is not intended to be limited to the embodiments, and the various numerical values, materials, and the like in the embodiments are merely examples. In the following descriptions, identical reference signs will be used for identical elements or elements having identical functions, and redundant descriptions thereof will not be given. Note that the descriptions will be given in the following order.

1. Overall Description of Information Processing Apparatus, Information Processing Method, and Information Processing Program According to Present Disclosure

2. First Embodiment

3. Second Embodiment

4. Variations

5. Other

[Overall Description of Information Processing Apparatus, Information Processing Method, and Information Processing Program According to Present Disclosure]

In an information processing apparatus, an information processing method, and an information processing program according to the present disclosure (these may be called simply “the present disclosure” hereinafter), whether or not data is presumed to be continuous data is determined on the basis of whether or not a write command from a host system side has been issued within a predetermined amount of time following an immediately-previous write command.

Although it depends on the configuration on the host system side and the like, a case is conceivable in which a plurality of write commands are issued from the host system side when writing a single file into the information processing apparatus. In such a case, the second and subsequent write commands are considered to have been issued not long after the previous write command. Accordingly, when the write command from the host system side has been issued not long after the immediately-previous write command, those write commands are presumed to correspond to processing of writing continuous data constituting a single file. Accordingly, whether or not the data is presumed to be continuous data can be determined by determining whether or not a write command from the host system side has been issued within a predetermined amount of time following an immediately-previous write command. Note that the “predetermined amount of time” may be set as appropriate on the basis of the specifications of the host system and the information processing apparatus, and so on.

In the present disclosure including the above-described preferred configuration, a configuration can be employed in which a size of the data transmitted from the host system side is confirmed, and whether or not the data is presumed to be continuous data is determined on the basis of whether or not the data is greater than or equal to a predetermined size.

Although it depends on the configuration on the host system side and the like, when the write size is only approximately 4 KB, for example, that data itself can be presumed to constitute a single file on its own. Conversely, when the write size exceeds 64 KB, for example, that data is presumed to be continuous with the data corresponding to the immediately-previous write command. This is because when writing data having a large file size, such as, for example, video data or image data, processing is performed so that data of a certain size is written in sequence. Accordingly, whether or not the data is presumed to be continuous data can be determined by determining the magnitude of the write size from the host system side. Note that the “predetermined size” may be set as appropriate on the basis of the specifications of the host system and the information processing apparatus, and so on.

In the present disclosure including the above-described various preferred configurations, a configuration can be employed in which when a file is designated to be read from the host system side, data stored in the file is read in advance on the basis of the metadata.

When a read command for a file is issued from the host system side, the information processing apparatus side can, on the basis of the metadata, read ahead the region where the binary data of the file is stored. This makes it possible to improve the reading speed.

In the present disclosure including the above-described various preferred configurations, a configuration can be employed in which the predetermined data amount is a data amount per page.

In this case, a configuration can be employed in which the information processing apparatus manages data in units of blocks, each block including a plurality of pages. A configuration can also be employed in which the information processing apparatus writes data to a block from which data has been deleted.

In this case, a configuration can be employed in which the metadata includes a flag indicating that the data is presumed to be continuous data, as well as information of a block and information of a page in which data was stored immediately before. Furthermore, a configuration can be employed in which data from the host system side and metadata are written for each of pages to be written to. Alternatively, a configuration can also be employed in which the data from the host system side and the metadata are respectively stored in independent recording regions.

Alternatively, in the present disclosure including the above-described preferred configuration, a configuration can be employed in which the predetermined data amount is a data amount per sector.

In this case, a configuration can be employed in which the information processing apparatus manages data in units of clusters, each cluster including a plurality of sectors. Additionally, a configuration can be employed in which the metadata includes a flag indicating that the data is presumed to be continuous data, as well as information of a sector in which data was stored immediately before. Furthermore, a configuration can be employed in which data from the host system side and metadata are written for each of sectors to be written to. Alternatively, a configuration can be employed in which the data from the host system side and the metadata are respectively stored in independent recording regions.

In the present disclosure, the medium to be written to is not particularly limited, and can be configured using well-known media, including semiconductor memory media such as flash memory and disk media such as FDD, CD-R, DVD-R, and HDD. In addition to these media, the information processing apparatus can be constituted by a controller than performs information processing. The controller can be constituted by a combination of computers, logic circuits, and the like, for example.

### First Embodiment

A first embodiment pertains to the information processing apparatus, information processing method, and information processing program according to the present disclosure.

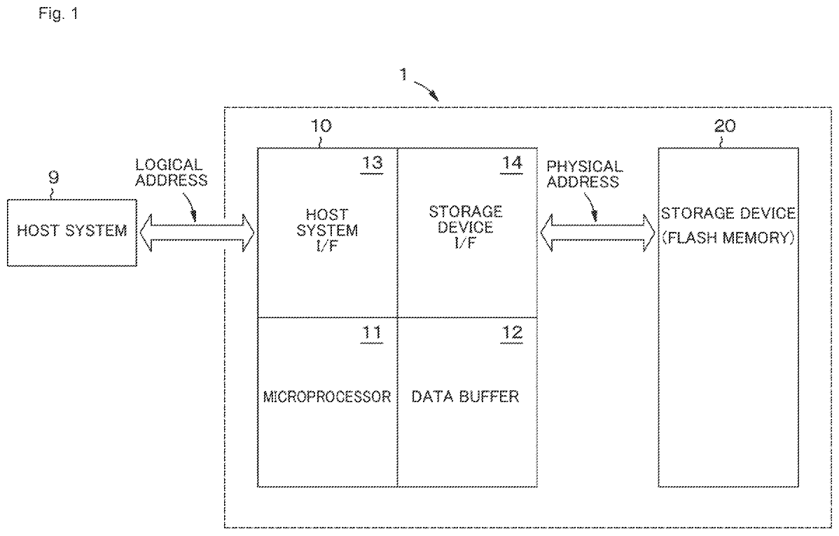

FIG. 1 is a schematic block diagram of the information processing apparatus according to a first embodiment.

An information processing apparatus 1 includes, for example, a storage device 20 constituted by flash memory, and a memory controller 10 that controls the storage device 20. The information processing apparatus 1 is removably connected to a host system 9, for example, and is used as a storage apparatus of the host system 9. In addition to personal computers, digital video cameras, and digital still cameras, mobile electronic terminals such as smartphones and mobile phones can be given as examples of the host system 9.

The memory controller 10 includes: a microprocessor 11 that controls the memory controller as a whole; a data buffer 12 constituted by RAM or the like; a host system I/F (reference sign 13) constituting an interface with the host system 9 side; and a storage device I/F (reference sign 14) constituting an interface with the storage device 20 side. The memory controller 10 operates on the basis of an information processing program stored in storage means, which is not shown. When writing data transmitted from the host system 9 side, a step of determining whether or not the transmitted data is presumed to be continuous data constituting a single file, and a step of, when the transmitted data is presumed to be continuous data, writing metadata indicating that the data is continuous data along with the data from the host system 9 side, are executed.

The host system I/F indicated by reference sign 13 performs communication with the host system 9 pertaining to commands related to reading and writing, as well as file data, logical address information, and the like. The storage device I/F indicated by reference sign 14 performs communication with the storage device 20 pertaining to commands controlling operations, data, physical address information, and the like.

The data buffer 12 temporarily holds data to be written to the storage device 20 or data read from the storage device 20. For example, the data to be read from the storage device 20 is held in the data buffer 12 until reception preparations are complete on the host system 9 side. Likewise, the data to be written to the storage device 20 is held in the data buffer 12 until write preparations are complete on the storage device 20 side.

The storage device 20 is constituted by what is known as NAND flash memory. In the storage device 20, writing is performed in units of a plurality of bits, called pages. As described above, data cannot be overwritten directly in a page in which something is already recorded, and instead, it is necessary to first delete the entire page. Additionally, the aforementioned pages are deleted in units of blocks, each of which contains a plurality of pages. Accordingly, the information processing apparatus 1 writes data to blocks from which data has been deleted.

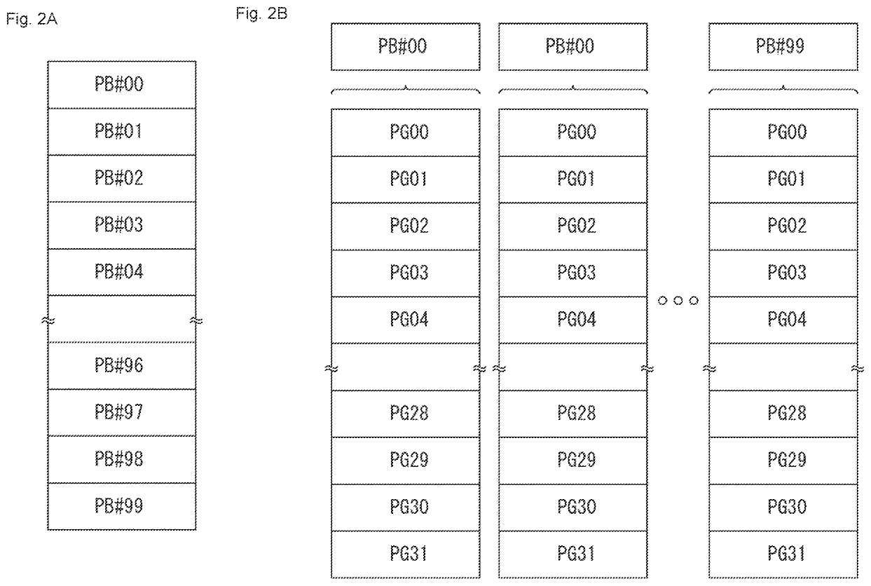

FIG. 2 is an explanatory diagram illustrating a relationship between blocks and pages in a storage device constituted by flash memory. FIG. 2A illustrates the structure of the block, and FIG. 2B illustrates the structure of the page included in the block.

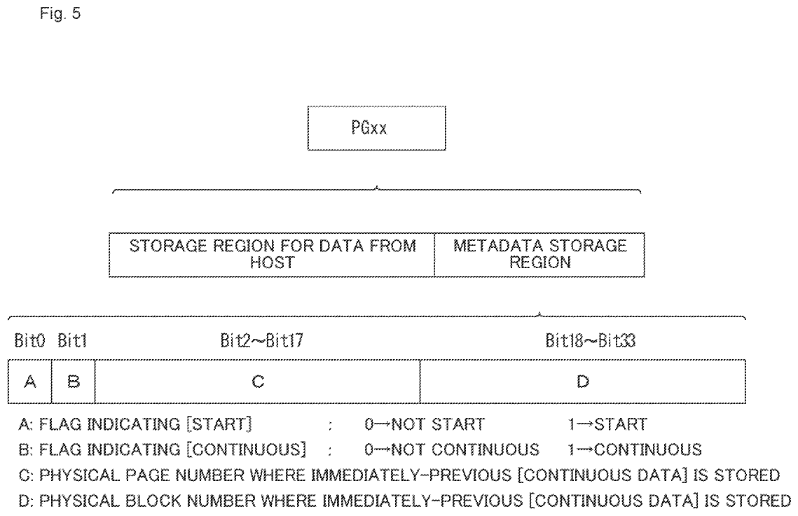

As illustrated in FIG. 2A, the storage device 20 includes a plurality of blocks indicated by reference signs PB#00 to PB#99, for example. Furthermore, as illustrated in FIG. 2B, each block is constituted by pages indicated by reference signs PG00 to PG31. As will be described later with reference to FIG. 5, each page is constituted by, for example, a 4096-bit data region and a 34-bit redundant region. Furthermore, as will be described later, the redundant region is used as a metadata storage region.

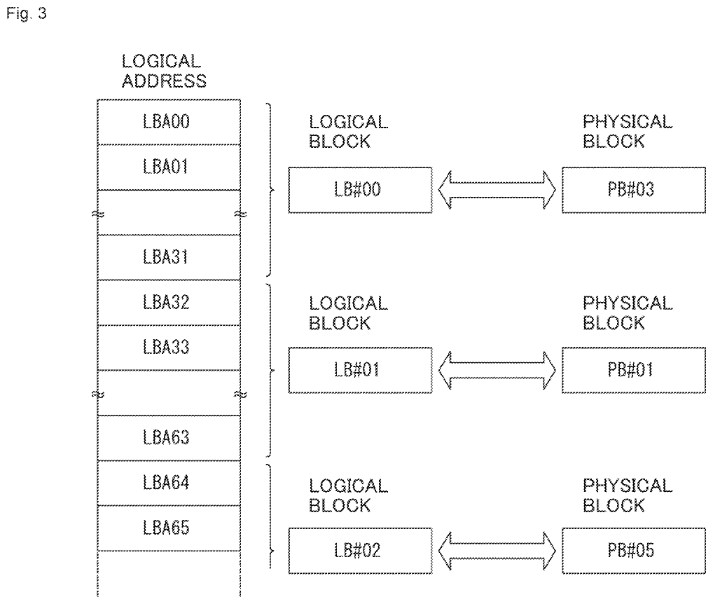

FIG. 3 is an explanatory diagram illustrating how a logical block indicated from a host system side and a physical block on the flash memory side can differ.

The host system 9 specifies a logical address and performs a write. FIG. 3 is an example in which the writing is performed having specified continuous logical addresses. The relationship is such that logical addresses LBA00 to LBA31 correspond to logical block LB#00, and logical addresses LBA32 to LBA63 correspond to logical block LB#01.

As described above, in NAND flash memory, data cannot be overwritten directly in a page in which something is already recorded, and instead, it is necessary to first delete the entire page. Furthermore, it is necessary to delete the aforementioned pages in units of blocks, each of which contains a plurality of pages. As such, when writing data, the correspondence relationship between the logical blocks and the physical blocks is not unique. FIG. 3 illustrates an example of a case where logical block LB#00 corresponds to physical block PB#03, logical block LB#01 corresponds to physical block PB#01, and logical block LB#02 corresponds to physical block PB#05.

An address conversion table indicating correspondence relationships between logical block addresses and physical block addresses is constructed within the memory controller 10, and does not involve the host system 9. As such, although the host system 9 side issues a command to write sequential data into sequential blocks, the data is actually written into non-sequential blocks in the storage device 20. In such a case, when the file system is corrupted, it is normally difficult to identify the plurality of blocks that store the data of the file which has been written.

Accordingly, in the information processing apparatus 1, when writing data transmitted from the host system 9 side, in the case where the data is presumed to be continuous data constituting a single file, metadata indicating that the data from the host system 9 side is continuous data is written along with the data. To be more specific, whether or not the data is presumed to be continuous data is determined on the basis of whether or not a write command from the host system 9 side has been issued within a predetermined amount of time following an immediately-previous write command.

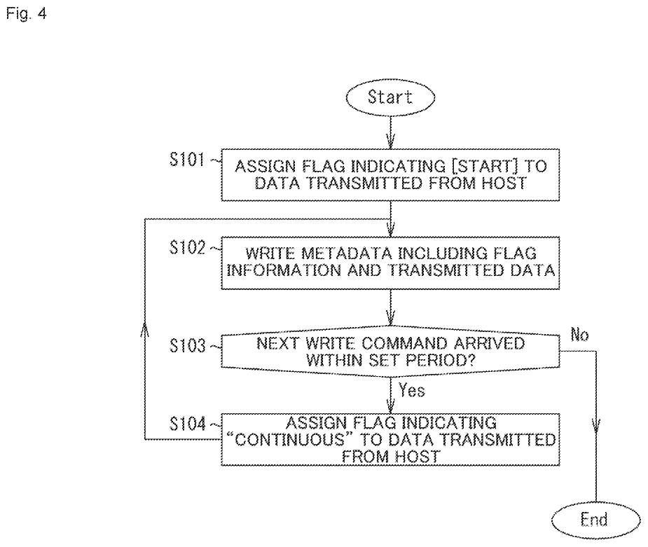

FIG. 4 is a schematic flowchart illustrating basic operations in write processing.

When a write command for a file is issued from the host system 9 side, the memory controller 10 assigns a flag indicating a [start] of the file to the transmitted data (step S101). Metadata including flag information, and the transmitted data, are then written (step S102).

When writing a single file to the information processing apparatus 1, write commands are normally issued from the host system 9 side multiple times. In such a case, the second and subsequent write commands are considered to be issued not long after the previous write command.

Upon determining that the next write command has arrived within a predetermined set period, the memory controller 10 presumes that the transmitted data received from the host system 9 side is continuous with the previous data, and assigns a flag indicating that the data is [continuous] to the transmitted data (step S103). Metadata including flag information, and the transmitted data, are then written (step S102). Then, basically, the above-described loop is repeated.

Note that when the next write command is not within the predetermined set period, the write is presumed to be a write for a different file. In this case, the sequence departs the above-described loop and returns to the Start in FIG. 4.

The basic operations of write processing according to the first embodiment have been described thus far.

FIG. 5 is a schematic diagram illustrating data stored in each of pages of the storage device.

In the information processing apparatus 1, data is accessed every predetermined data amount, and more specifically, every data amount in units of pages. The information processing apparatus 1 manages the data in units of blocks, each block including a plurality of pages. Each page is constituted by, for example, a 4096-bit data region and a 34-bit redundant region. Furthermore, the redundant region is used as a metadata storage region. The metadata includes a flag indicating that the data is presumed to be continuous data, as well as information of the block and information of the page in which data was stored immediately before.

In the example illustrated in the drawing, a [segment A], to which Bit0 of the metadata storage region corresponds, corresponds to a flag indicating the [start] of the file, and has a meaning of [0: not the start] or [1: the start]. Additionally, a [segment B], to which Bit1 of the metadata storage region corresponds, corresponds to a flag indicating information pertaining to the [continuity] of the data, and has a meaning of [0: not continuous] or [1: continuous]. A physical page number in which [continuous data] one instance previous is stored is stored in [segment C], to which Bit2 to Bit17 correspond, and a physical block number in which the [continuous data] one instance previous is stored is stored in [segment D], to which Bit18 to Bit33 correspond. Then, data and metadata are written from the host system 9 side for each of pages to be written to.

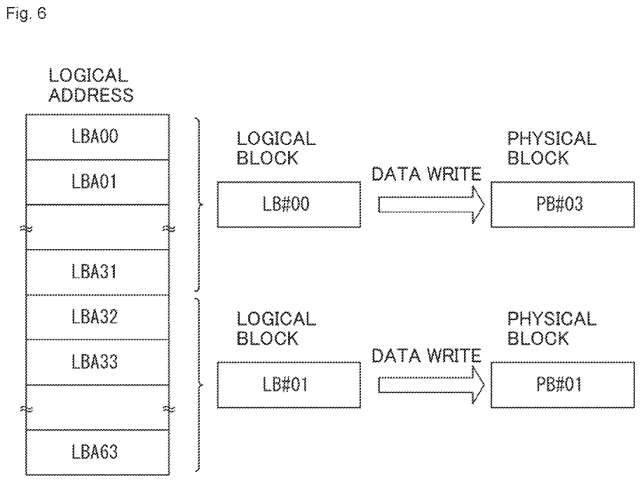

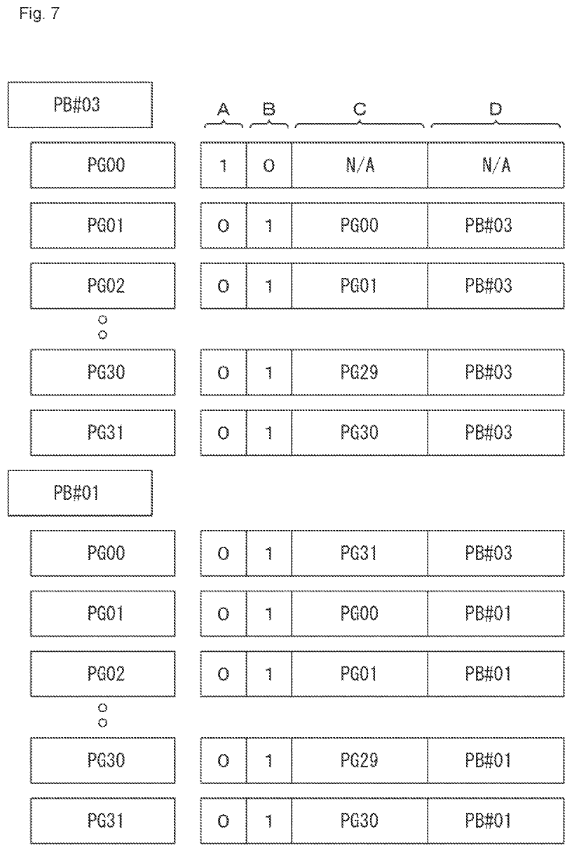

An example of write processing in the storage device 20 constituted by flash memory will be described below with reference to FIG. 6 and FIG. 7.

FIG. 6 is an explanatory diagram illustrating an example of write processing in the storage device. FIG. 7 is an explanatory diagram illustrating details of metadata written in each page of the storage device in the operations illustrated in FIG. 6.

The example illustrated in FIG. 6 is an example in which data specified by logical addresses LBA00 to LBA63 is written from the host system 9 side to the storage device 20 side. Here, logical addresses LBA00 to LBA31 constitute logical block LB#00, and logical addresses LBA32 to LBA63 constitute logical block LB#01. The data of logical block LB#00 is assumed to be written to physical block PB#03 of the storage device 20, and the data of logical block LB#01 is assumed to be written to physical block PB#01 of the storage device 20.

First, the memory controller 10 assigns the flag indicating [start] via the transmitted data specified by logical address LBA00 (step S101 in FIG. 4). Then, the data from the host system 9 side and the metadata including the flag indicating [start] are written to page PG00 of physical block PB#03 (step S102 in FIG. 4).

As illustrated in FIG. 5, the metadata includes the flag indicating [start], the flag indicating [continuous], and information of the block and information of the page in which data was stored immediately before. It is assumed that when the flag indicating [start] is assigned, the flag indicating [continuous] is set to 0. Additionally, the information of the block and information of the page in which data was stored immediately before are undefined. Thus as illustrated in FIG. 7, the metadata in page PG00 of physical block PB#03 is as follows:

[Segment A: 1]

[Segment B: 0]

[Segment C: N/A]

[Segment D: N/A]

Assuming that there is a subsequent write command within the predetermined set period, the memory controller 10 assigns a flag indicating [continuous] to the data transmitted from the host (steps S103 and S104 in FIG. 4). The metadata includes a flag indicating that the data is presumed to be continuous data, as well as information of the block and information of the page in which data was stored immediately before. The metadata in page PG01 of physical block PB#03 is as follows:

[Segment A: 0]

[Segment B: 1]

[Segment C: PG00]

[Segment D: PB#03]

The same processing is performed thereafter until page PG31 of physical block PB#03. The next write is then made in physical block PB#01. The metadata in page PG00 of physical block PB#01 is as follows:

[Segment A: 0]

[Segment B: 1]

[Segment C: PG31]

[Segment D: PB#03]

The metadata in the following page PG01 of physical block PB#01 is as follows:

[Segment A: 0]

[Segment B: 1]

[Segment C: PG00]

[Segment D: PB#01]

The same processing is performed thereafter until page PG31 of physical block PB#01.

In the storage device 20 into which such metadata has been written, even if the index information of the file allocation table has been damaged or lost, and the file system is corrupted, the information in the metadata can be used as a clue for tracing the plurality of pages to which the specific file has been written.

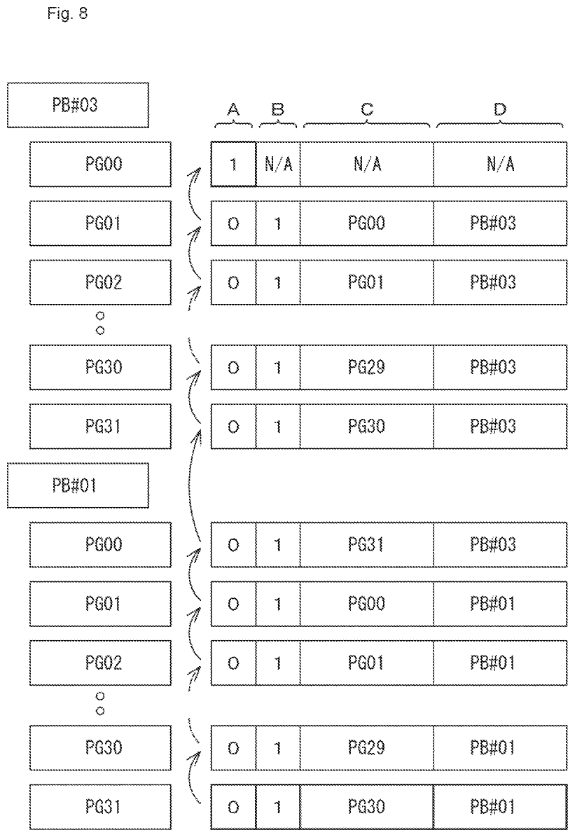

FIG. 8 is an explanatory diagram illustrating how a related page can be accessed on the basis of metadata regardless of file system information.

For example, if page PG31 of physical block PB#01 is expected to be end information of a file, the page written immediately before is PG30 and the block is PB#01, i.e., [segment B: 1],a and thus based on the metadata of page PG31, it can be reasoned through analogy that the data is continuous data. Repeating this leads to page PG00 of physical block PB#01.

Then, based on the metadata of page PG00, the page written immediately before is PG31, and the block is PB#03, i.e., [segment B: 1], and thus it can be reasoned through analogy that the data is continuous data. Repeating the above-described operations results in [segment A: 1] for the metadata of page PG00, and it can therefore be seen that this is the starting position of the file.

Accordingly, it can be presumed that the data of a given file is constituted by pages PG00 to PG31 of physical block PB#03 and pages PG00 to PG31 of physical block PB#01. By reading out the binary data contained in these pages, an attempt can be made to recover the file.

As described thus far, according to the first embodiment, by referring to the information in the metadata, it is possible to identify, to a certain extent, a block or the like in which data of a written file is stored. As such, even if the data of a file is stored in discrete blocks or the like, an attempt can be made to recover the file.

Note that the foregoing describes data and metadata being written from the host system 9 side for each of pages to be written to. Depending on the case, a configuration can also be employed in which the data from the host system 9 side and the metadata are respectively stored in independent recording regions. This is, for example, a configuration in which a specific block stores metadata only.

Additionally, according to the information processing apparatus 1, by referring to the information in the metadata, the block or the like in which the data of a written file is stored can be identified. Accordingly, a configuration can also be employed in which when a file is designated to be read from the host system 9 side, data stored in the file is read in advance on the basis of the metadata. This makes it possible to improve the data readout performance.

Additionally, by providing the host system 9 side with a function for reading out data on the basis of the continuity of the data, the host system 9 can, as necessary, read out data from the information processing apparatus 1 while confirming the continuity of data that has been written continuously when that data was written.

Additionally, an aspect is also possible in which the host system 9 side has a function for communicating the continuity of data to the information processing apparatus 1 in advance, and the information processing apparatus 1 generates metadata on the basis of the data continuity information communicated from the host system 9 side and stores the metadata along with the data of the file.

### Second Embodiment

A second embodiment also pertains to the information processing apparatus, information processing method, and information processing program according to the present disclosure.

The first embodiment described a configuration in which whether or not the data is presumed to be continuous data is determined on the basis of whether or not a write command from the host system side has been issued within a predetermined amount of time following an immediately-previous write command.

When the data from the host system side is continuous, the size of the data sent from the host system is normally expected to be a certain size. Conversely, the discontinuity or continuity of data can be presumed by considering the size of the data which is transmitted.

In the second embodiment, in addition to the first embodiment, a size of the data transmitted from the host system side is confirmed, and whether or not the data is presumed to be continuous data is determined on the basis of whether or not the data is greater than or equal to a predetermined size.

A schematic block diagram of an information processing apparatus 2 according to the second embodiment may be the same as FIG. 1, but with “information processing apparatus 1” replaced with “information processing apparatus 2”.

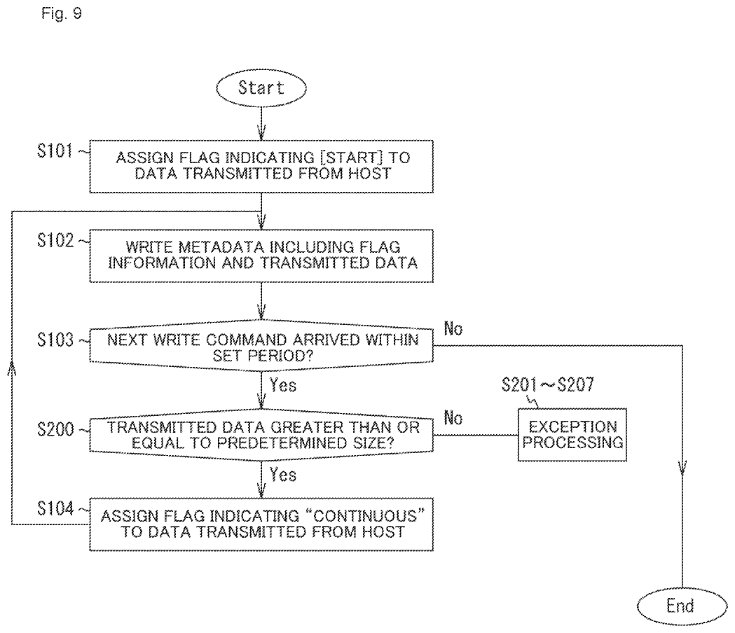

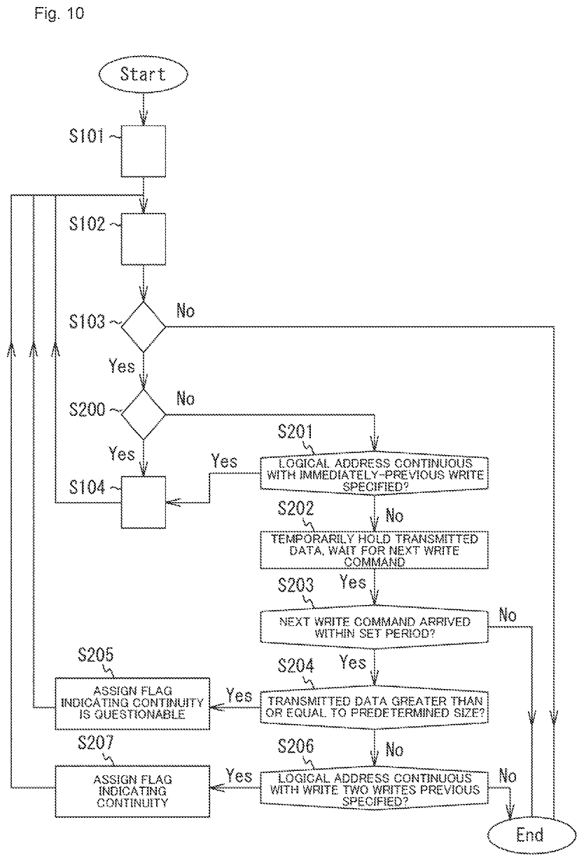

FIG. 9 is a schematic flowchart illustrating basic operations in write processing including a determination of the size of transmitted data. FIG. 10 is a schematic flowchart illustrating details of exception processing in FIG. 9.

The operations illustrated in FIG. 9 basically correspond to making a determination as to whether the transmitted data is greater than or equal to a predetermined size (step S200) between (step S103) and (step S104) in FIG. 4 referred to in the first embodiment. When the transmitted data is not greater than or equal to the predetermined size, exception processing constituted by steps S201 to S207 is performed, under the assumption that the continuity is questionable. The exception processing will be described below with reference to the drawings.

FIG. 10 is a schematic flowchart illustrating details of exception processing in FIG. 9.

When the transmitted data is not greater than or equal to the predetermined size, first, the memory controller 10 determines whether or not a logical address continuous with the write performed one write previous is designated in the write command from the host system 9 side (step S201).

When this determination is [Yes], the memory controller 10 performs the processing of (step S104) and then returns to (step S102). On the other hand, when the determination is [No], the memory controller 10 holds the transmitted data temporarily, waits for the next write command (step S202), and determines whether or not the next write command has arrived within the predetermined set period (step S203).

When the determination in (step S203) is [No], it is presumed that the write is a write for a different file. The memory controller 10 therefore exits the loop, described below, and returns to Start in FIG. 4. Note that the temporarily-held data may be processed as the first data of the different file. On the other hand, when the determination in (step S203) is [Yes], it is determined whether the transmitted data is greater than or equal to the predetermined size (step S204).

When the determination in (step S204) is [Yes], it is presumed that the continuity with the previous data is questionable, and a flag indicating [continuity questionable] for the data is assigned to the transmitted data (step S205). The sequence then returns to (step S102) and the processing is repeated. Note that the flag indicating [continuity questionable] may be assigned to both the temporarily-held data and the data of the next write command, or the flag indicating [continuity questionable] may be assigned to the former, and the flag indicating [continuous] may be assigned to the latter.

When the determination in (step S204) is [No], it is determined whether or not a logical address continuous with the write two writes previous has been designated from the host system 9 side (step S206).

When the determination in (step S206) is [Yes], it is presumed that there is continuity with the previous data, and a flag indicating [continuous] for the data is assigned to the transmitted data (step S207). The sequence then returns to (step S102) and the processing is repeated. Note that the flag indicating [continuous] may be assigned to both the temporarily-held data and the data of the next write command.

When the determination in (step S206) is [No], it is presumed that the write is a write for a different file. The memory controller 10 therefore exits the loop, described below, and returns to Start in FIG. 4. Note that the temporarily-held data may be processed as the first data of the different file.

The basic operations of write processing according to the second embodiment have been described thus far.

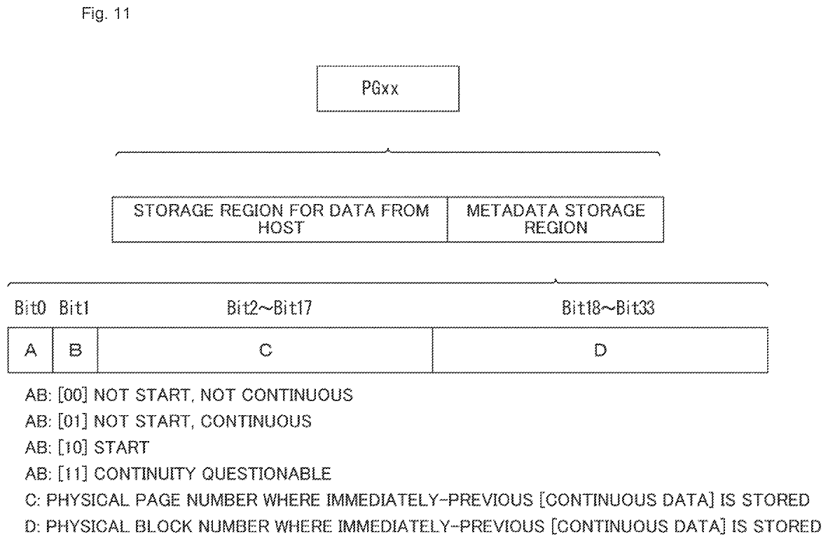

As described thus far, according to the second embodiment, a flag is assigned even when the continuity is questionable. According to the first embodiment, [segment A] and [segment B] indicated in FIG. 5 are each used independently. As illustrated in FIG. 11, in the second embodiment, for example, by handling [segment A] and [segment B] as two consecutive bits, a flag such as [11] is assigned when the continuity is questionable.

[Variations]

In each of the embodiments described above, the storage device is described as being constituted by flash memory. The storage device used in the present disclosure is not limited to flash memory, however, and a disk device such as an HDD can also be used. In the case of a disk device, a configuration can be employed in which the predetermined data amount is a data amount per sector. In this case, a configuration can be employed in which the information processing apparatus manages data in units of clusters, each cluster including a plurality of sectors.

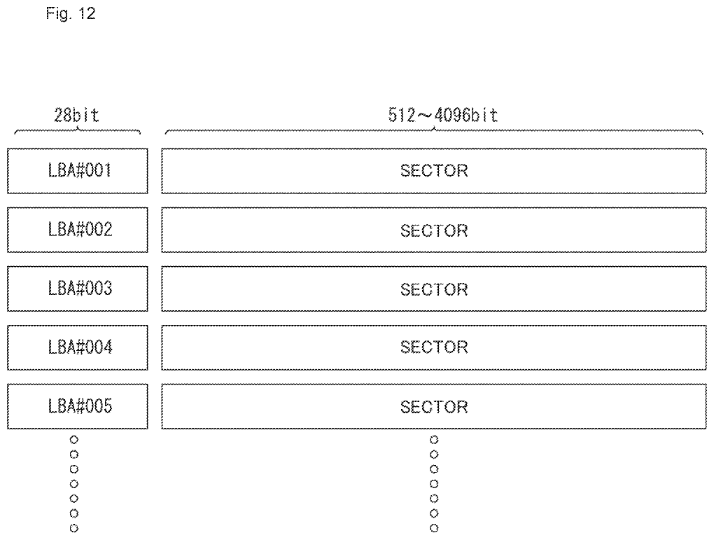

An example of the identification of a sector in an HDD will be described here. FIG. 12 is an explanatory diagram illustrating a case of identifying a sector through LBA (Logical Block Addressing).

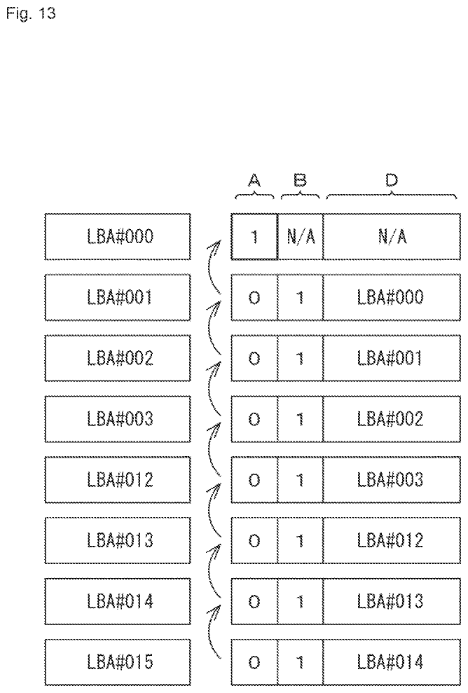

To identify a page in flash memory, it has been necessary to identify the number of the block to which the page belongs and the page number within the block. However, in the case of LBA, each sector is identified by a unique number. Accordingly, a configuration can be employed in which the metadata includes a flag indicating that the data is presumed to be continuous data, as well as information of a sector in which data was stored immediately before. FIG. 13 is an explanatory diagram illustrating details of metadata in a case of identifying a sector through LBA.

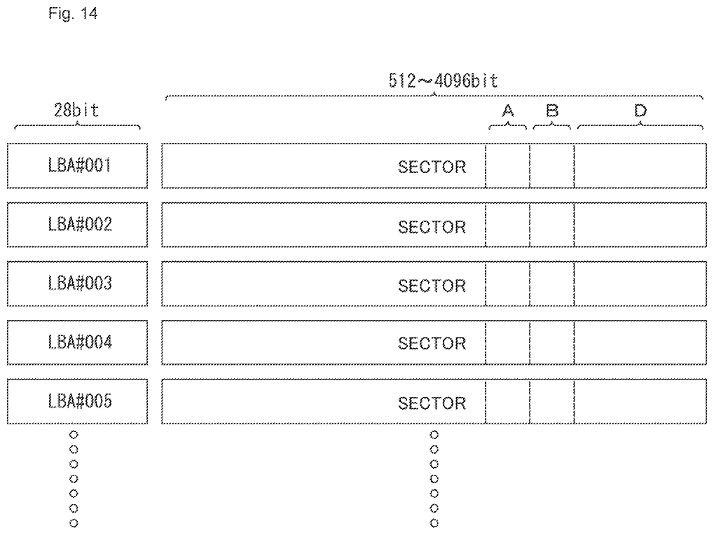

In the variations as well, a configuration can be employed in which data and metadata are written from the host system 9 side for each of sectors to be written to. FIG. 14 is an explanatory diagram illustrating an example of a case where data and metadata from the host system 9 side are both written to a sector.

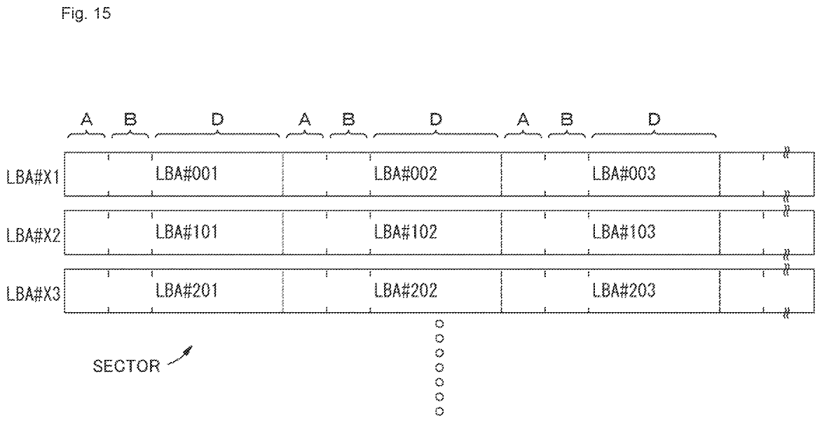

Alternatively, a configuration can be employed in which the data from the host system 9 side and the metadata are respectively stored in independent recording regions. For example, all the sectors in a predetermined region of the HDD can be used to store metadata, and data and metadata can be stored in independent recording regions. FIG. 15 is an example of the storage of metadata in a sector for recording metadata.

Although embodiments of the present disclosure have been described in detail above, the present disclosure is not limited to the above-described embodiments, and many variations based on the technical spirit of the present disclosure are possible.

Note that the technique of the present disclosure can also take on configurations such as those described below.

[A1]

An information processing apparatus in which data is accessed every predetermined data amount, wherein

when writing data transmitted from a host system side, in the case where the data is presumed to be continuous data constituting a single file, metadata indicating that the data from the host system side is continuous data is written along with the data from the host system side.

[A2]

The information processing apparatus according to the foregoing [A1], wherein whether or not the data is presumed to be continuous data is determined on the basis of whether or not a write command from the host system side has been issued within a predetermined amount of time following an immediately-previous write command.

[A3]

The information processing apparatus according to the foregoing [A1] or [A2], wherein

a size of the data transmitted from the host system side is confirmed, and whether or not the data is presumed to be continuous data is determined on the basis of whether or not the data is greater than or equal to a predetermined size.

[A4]

The information processing apparatus according to any one of the foregoing [A1] to [A3], wherein

when a file is designated to be read from the host system side, data stored in the file is read in advance on the basis of the metadata.

[A5]

The information processing apparatus according to any one of the foregoing [A1] to [A4], wherein

the predetermined data amount is a data amount per page.

[A6]

The information processing apparatus according to the foregoing [A5], wherein the information processing apparatus manages data in units of blocks, each block including a plurality of pages.

[A7]

The information processing apparatus according to the foregoing [A6], wherein the information processing apparatus writes data to a block from which data has been deleted.

[A8]

The information processing apparatus according to the foregoing [A6] or [A7], wherein

the metadata includes a flag indicating that the data is presumed to be continuous data, as well as information of a block and information of a page in which data was stored immediately before.

[A9]

The information processing apparatus according to the foregoing [A8], wherein data from the host system side and metadata are written for each of pages to be written to.

[A10]

The information processing apparatus according to the foregoing [A8], wherein the data from the host system side and the metadata are respectively stored in independent recording regions.

[A11]

The information processing apparatus according to the foregoing [A1], wherein the predetermined data amount is a data amount per sector.

[A12]

The information processing apparatus according to the foregoing [A11], wherein the information processing apparatus manages data in units of clusters, each cluster including a plurality of sectors.

[A13]

The information processing apparatus according to the foregoing [A11] or [A12], wherein

the metadata includes a flag indicating that the data is presumed to be continuous data, as well as information of a sector in which data was stored immediately before.

[A14]

The information processing apparatus according to the foregoing [A13], wherein data from the host system side and metadata are written for each of sectors to be written to.

[A15]

The information processing apparatus according to the foregoing [A13], wherein the data from the host system side and the metadata are respectively stored in independent recording regions.

[B1]

An information processing method including, when writing data transmitted from a host system side in an information processing apparatus in which data is accessed every predetermined data amount:

a step of determining whether or not the transmitted data is presumed to be continuous data constituting a single file, and

a step of, when the data is presumed to be continuous data, writing metadata indicating that the data from the host system side is continuous data along with the data from the host system side.

[B2]

The information processing method according to the foregoing [B1], wherein whether or not the data is presumed to be continuous data is determined on the basis of whether or not a write command from the host system side has been issued within a predetermined amount of time following an immediately-previous write command.

[B3]

The information processing method according to the foregoing [B1] or [B2], wherein a size of the data transmitted from the host system side is confirmed, and whether or not the data is presumed to be continuous data is determined on the basis of whether or not the data is greater than or equal to a predetermined size.

[B4]

The information processing method according to any one of the foregoing [B1] to [B3], wherein

when a file is designated to be read from the host system side, data stored in the file is read in advance on the basis of the metadata.

[B5]

The information processing method according to any one of the foregoing [B1] to [B4], wherein

the predetermined data amount is a data amount per page.

[B6]

The information processing method according to the foregoing [B5], wherein data is managed in units of blocks, each block including a plurality of pages.

[B7]

The information processing method according to the foregoing [B6], wherein data is written to a block from which data has been deleted.

[B8]

The information processing method according to the foregoing [B6] or [B7], wherein the metadata includes a flag indicating that the data is presumed to be continuous data, as well as information of a block and information of a page in which data was stored immediately before.

[B9]

The information processing method according to the foregoing [B8], wherein data from the host system side and metadata are written for each of pages to be written to.

[B10]

The information processing method according to the foregoing [B8], wherein the data from the host system side and the metadata are respectively stored in independent recording regions.

[B11]

The information processing method according to the foregoing [B1], wherein the predetermined data amount is a data amount per sector.

[B12]

The information processing method according to the foregoing [B11], wherein data is managed in units of clusters, each cluster including a plurality of sectors.

[B13]

The information processing method according to the foregoing [B11] or [B12], wherein

the metadata includes a flag indicating that the data is presumed to be continuous data, as well as information of a sector in which data was stored immediately before.

[B14]

The information processing method according to the foregoing [B13], wherein data from the host system side and metadata are written for each of sectors to be written to.

[B15]

The information processing method according to the foregoing [B13], wherein the data from the host system side and the metadata are respectively stored in independent recording regions.

[C1]

An information processing program executed by a computer, the program controlling an information processing apparatus in which data is accessed every predetermined data amount, the program including, when writing data transmitted from a host system side:

a step of determining whether or not the transmitted data is presumed to be continuous data constituting a single file; and

a step of, when the data is presumed to be continuous data, writing metadata indicating that the data from the host system side is continuous data along with the data from the host system side.

[C2]

The information processing program according to the foregoing [C1], wherein whether or not the data is presumed to be continuous data is determined on the basis of whether or not a write command from the host system side has been issued within a predetermined amount of time following an immediately-previous write command.

[C3]

The information processing program according to the foregoing [C1] or [C2], wherein

a size of the data transmitted from the host system side is confirmed, and whether or not the data is presumed to be continuous data is determined on the basis of whether or not the data is greater than or equal to a predetermined size.

[C4]

The information processing program according to any one of the foregoing [C1] to [C3], wherein

when a file is designated to be read from the host system side, data stored in the file is read in advance on the basis of the metadata.

[C5]

The information processing program according to any one of the foregoing [C1] to [C4], wherein

the predetermined data amount is a data amount per page.

[C6]

The information processing program according to the foregoing [C5], wherein data is managed in units of blocks, each block including a plurality of pages.

[C7]

The information processing program according to the foregoing [C6], wherein data is written to a block from which data has been deleted.

[C8]

The information processing program according to the foregoing [C6] or [C7], wherein

the metadata includes a flag indicating that the data is presumed to be continuous data, as well as information of a block and information of a page in which data was stored immediately before.

[C9]

The information processing program according to the foregoing [C8], wherein data from the host system side and metadata are written for each of pages to be written to.

[C10]

The information processing program according to the foregoing [C8], wherein the data from the host system side and the metadata are respectively stored in independent recording regions.

[C11]

The information processing program according to the foregoing [C1], wherein the predetermined data amount is a data amount per sector.

[C12]

The information processing program according to the foregoing [C11], wherein data is managed in units of clusters, each cluster including a plurality of sectors.

[C13]

The information processing program according to the foregoing [C11] or [C12], wherein

the metadata includes a flag indicating that the data is presumed to be continuous data, as well as information of a sector in which data was stored immediately before.

[C14]

The information processing program according to the foregoing [C13], wherein data from the host system side and metadata are written for each of sectors to be written to.

[C15]

The information processing program according to the foregoing [C13], wherein the data from the host system side and the metadata are respectively stored in independent recording regions.

### REFERENCE SIGNS LIST

1 Information processing apparatus

10 Controller

11 Microprocessor

12 Data buffer

13 Host system I/F

14 Storage device I/F

20 Storage device

1. An information processing apparatus in which data is accessed every predetermined data amount, wherein
when writing data transmitted from a host system side, in the case where the data is presumed to be continuous data constituting a single file, metadata indicating that the data from the host system side is continuous data is written along with the data from the host system side.

2. The information processing apparatus according to claim 1, wherein
whether or not the data is presumed to be continuous data is determined on the basis of whether or not a write command from the host system side has been issued within a predetermined amount of time following an immediately-previous write command.

3. The information processing apparatus according to claim 1, wherein
a size of the data transmitted from the host system side is confirmed, and whether or not the data is presumed to be continuous data is determined on the basis of whether or not the data is greater than or equal to a predetermined size.

4. The information processing apparatus according to claim 1, wherein
when a file is designated to be read from the host system side, data stored in the file is read in advance on the basis of the metadata.

5. The information processing apparatus according to claim 1, wherein
the predetermined data amount is a data amount per page.

6. The information processing apparatus according to claim 5, wherein
the information processing apparatus manages data in units of blocks, each block including a plurality of pages.

7. The information processing apparatus according to claim 6, wherein
the information processing apparatus writes data to a block from which data has been deleted.

8. The information processing apparatus according to claim 6, wherein
the metadata includes a flag indicating that the data is presumed to be continuous data, as well as information of a block and information of a page in which data was stored immediately before.

9. The information processing apparatus according to claim 8, wherein
data from the host system side and metadata are written for each of pages to be written to.

10. The information processing apparatus according to claim 8, wherein
the data from the host system side and the metadata are respectively stored in independent recording regions.

11. The information processing apparatus according to claim 1, wherein
the predetermined data amount is a data amount per sector.

12. The information processing apparatus according to claim 11, wherein
the information processing apparatus manages data in units of clusters, each cluster including a plurality of sectors.

13. The information processing apparatus according to claim 11, wherein
the metadata includes a flag indicating that the data is presumed to be continuous data, as well as information of a sector in which data was stored immediately before.

14. The information processing apparatus according to claim 13, wherein
data from the host system side and metadata are written for each of sectors to be written to.

15. The information processing apparatus according to claim 13, wherein
the data from the host system side and the metadata are respectively stored in independent recording regions.

16. An information processing method comprising, when writing data transmitted from a host system side in an information processing apparatus in which data is accessed every predetermined data amount,
a step of determining whether or not the transmitted data is presumed to be continuous data constituting a single file; and
a step of, when the data is presumed to be continuous data, writing metadata indicating that the data from the host system side is continuous data along with the data from the host system side.

17. An information processing program executed by a computer, the program controlling an information processing apparatus in which data is accessed every predetermined data amount, the program comprising:
when writing data transmitted from a host system side,
a step of determining whether or not the transmitted data is presumed to be continuous data constituting a single file; and
a step of, when the data is presumed to be continuous data, writing metadata indicating that the data from the host system side is continuous data along with the data from the host system side.
